(19) United States
(12) Patent Application Publication
(10) Pub. No.: US 2007/0169204 A1
(43) Pub. Date: Jul. 19, 2007

(54) System and method for dynamic security access

(75) Inventors: Janani Janakiraman, Austin, TX (US); Martin Guenter Schmidt, Pflugerville, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation

(21) Appl. No.: 11/333,438

(22) Filed: Jan. 17, 2006

(51) Int. Cl. H04L 9/32; G06K 9/00; H04L 9/00; G06F 17/30; H04K 1/00; G06F 15/16; G06F 7/04; G06F 7/58; H03M 1/68; G06K 19/00; H04N 7/16

(52) U.S. Cl. 726/28; 726/5; 726/6; 726/7; 713/182

(57) ABSTRACT

A system and method for dynamic security access. A dynamic security system receives a resource request from a user. The dynamic security system computes a dynamic user security value using a user security formula and user attribute values corresponding to the user. In addition, the dynamic security system computes a resource security value using a resource security formula and resource attribute values corresponding to the resource. Once computed, the dynamic security system compares the dynamic user security value with the resource security value and, if the dynamic user security value is greater than or equal to the resource security value, the dynamic security system grants resource to the user.

### BACKGROUND OF THE INVENTION

1. Technical Field

The present invention relates to a system and method for dynamic security access. More particularly, the present invention relates to a system and method for dynamically computing a user's dynamic user security value along with a resource's resource security value, and granting the user access to the resource based upon the computed values.

2. Description of the Related Art

Computer systems typically include security mechanisms for authorizing users and granting access to resources. In policy-based networking, a policy is a formal set of statements that define how the network's resources are allocated among its clients (users). Network managers typically create policies and policy statements to specify resource allocation, which are stored in a policy repository.

In information technology (IT) environments, security policies describe which users have access to which resources and under what conditions. For example, all employees may have authorization to access a company phone directory, while only top management has authorization to access payroll. Other prior art models involve assigning static security levels to users and resources, and setting security policies based upon the static user and resource levels. For example, a company may assign security levels based upon a user's citizenship or department role.

Existing art may also use access control lists to either grant or deny a user access to a particular resource. An access control list usually includes “user identifier/rights” pairs that specify access permissions for a particular user. When used to identify user permissions, access control lists typically provide users and/or groups access to a resource based upon the users' requested actions. For example, user “X” may access resource “W” to perform function-“Z.”,

A challenge found, however, is that existing art is static in nature and does not take into account dynamic user and resource variables. For example, many users may modify a resource while the resource is being drafted, but when the resource is approved, only a select few may modify the resource. In addition, the threat of security breaches may be higher when a user logs onto a computer system from a remote location as opposed to logging on locally. However, existing art grants the user the same access privileges whether the user logs on locally or remotely.

Another challenge found with existing art is that it does not take into account a user's prior access history when the user gains access within a certain amount of attempts. For example, a malicious user may attempt to log in multiple times and then successfully logs in on the last allowable attempt. In this example, existing art allows the user access to files, once logged in, based upon the user identifier that the malicious user used to gain access, regardless of whether the file is confidential or not.

What is needed, therefore, is a system and method that dynamically computes security access based upon dynamically changing user and resource conditions.

### SUMMARY

It has been discovered that the aforementioned challenges are resolved using a system and method for dynamically computing a user's dynamic user security value along with a resource's resource security value, and granting the user access to the resource based upon the computed values.

A user wishes to access a resource, such as a document or database record, and sends a resource request to a dynamic security system. The dynamic security system receives the resource request, and retrieves user attributes that correspond to the user, such as management level, job position, time of service, etc. In addition, the dynamic security system identifies other user attributes, such as the user's login time, login location, and prior access history.

The dynamic security system retrieves a user security formula that includes user attributes and, in turn, retrieves user attribute values based upon the user. For example, the user security formula may include user attributes such as a management attribute and a position attribute. In this example, the dynamic security system identifies the user's management level and position using the user attributes, and retrieves corresponding user attribute values from a look-up table.

The dynamic security system uses the user security formula and the user attribute values to compute a dynamic user security value. The dynamic user security value is a security value associated with the user at the time of the resource request, and changes based upon the user's attributes as well as the user's login session properties (local, remote, prior access history, etc.).

For the resource, the dynamic security system computes a resource security value. In order to perform the computation, the dynamic security system retrieves resource attributes that correspond to the requested resource, which may include the resource's document type (program, code, etc.) and document status (draft, approved, etc.). The dynamic security system then retrieves a resource security formula, and retrieves resource attribute values for use in the resource security formula based upon the resource. In turn, the dynamic security system computes a resource security value using the resource security formula and the retrieved resource attribute values. In one embodiment, the dynamic security system also uses fixed values that are based upon the type of the resource request, such as whether the user wishes to view a resource or write to a resource.

Once the dynamic security system completes security value computations, the dynamic security system determines whether to authorize the resource request based upon the dynamic user security value and the resource security value. These values may be numerically based or broad categories of permission (e.g., highest, high, medium, etc.).

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a dynamic security system granting a user access to a resource based upon a computed dynamic user security value and a resource security value;

FIG. 2A is a table showing various user attribute values;

FIG. 2B is a table showing various resource attribute values;

FIG. 3 is a high level flowchart showing steps taken in computing a dynamic user security value and a resource security value, and granting a user access to a resource based upon the dynamic user security value and the resource security value;

FIG. 4 is a flowchart showing steps taken in computing a dynamic user security value using a user security formula and a plurality of user attribute values;

FIG. 5 is a flowchart showing steps taken in computing a resource security value using a resource security formula and a plurality of resource attribute values; and

FIG. 6 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

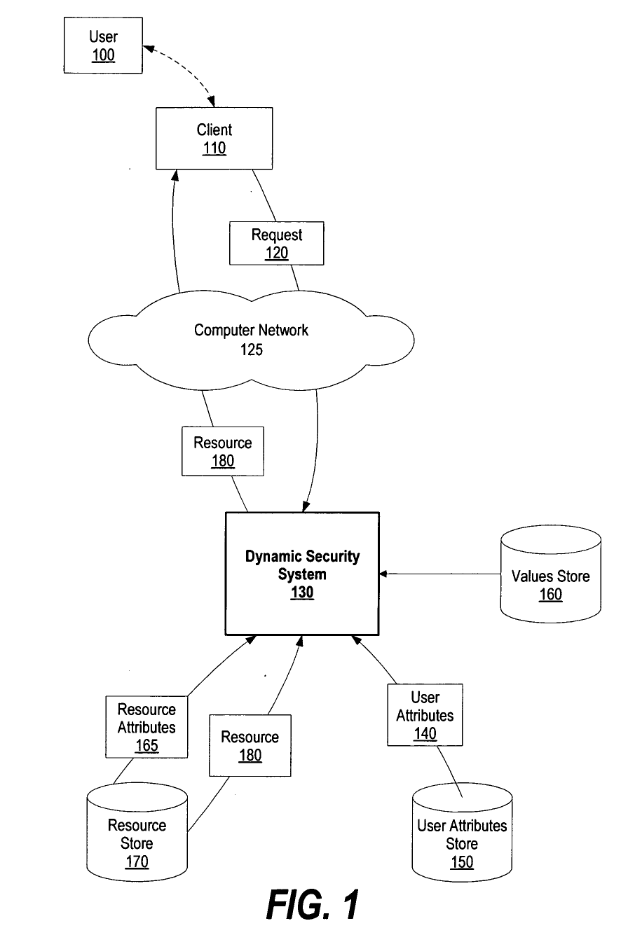

FIG. 1 is a diagram showing a dynamic security system granting a user access to a resource based upon a computed dynamic user security value and a resource security value. User 100 uses client 110 to send request 120 to dynamic security system 130 through computer network 125, such as the Internet. Request 120 corresponds to a resource that user 100 wishes to access, such as a document or database record.

Dynamic security system 130 receives request 120, and retrieves user attributes 140 from user attributes store 150 that correspond to user 100, such as management level, job position, time of service, etc. In addition, dynamic security system 130 identifies other user attributes, such as user 100's login time, login location (e.g., local or remote), and prior access history.

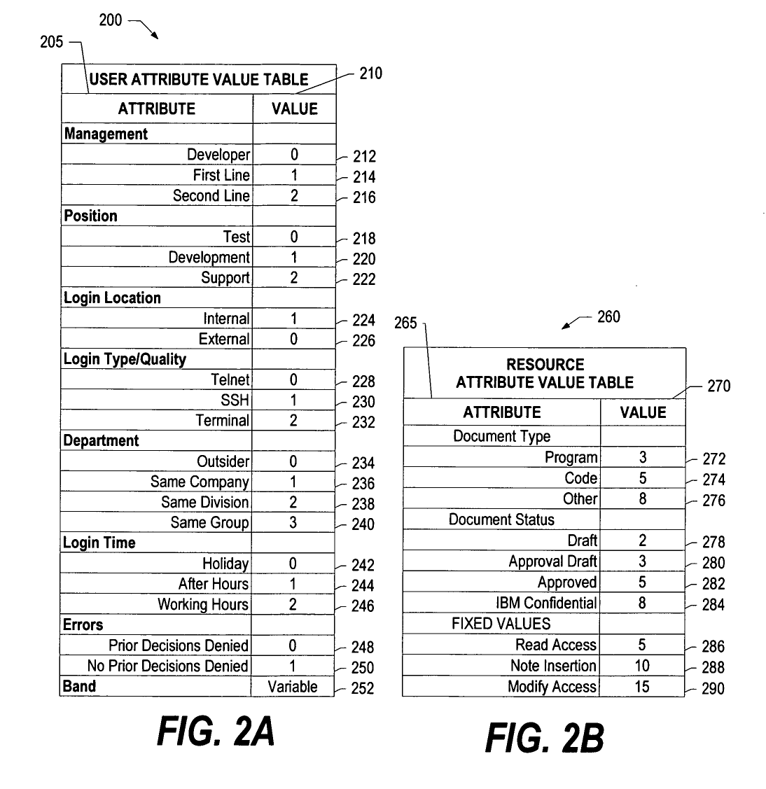

Dynamic security system 130 retrieves a user security formula from values store 160 that includes user attributes. Dynamic security system 130 identifies the user attributes, and retrieves associated user attribute values based upon user attributes 140. For example, the user security formula may include user attributes such as a management attribute and a position attribute. In this example, dynamic security system 130 identifies user 100's management level and position using user attributes 140, and retrieves corresponding user attribute values from a look-up table located in values store 160 (see FIG. 2A and corresponding text for further details regarding user attribute value look up table properties).

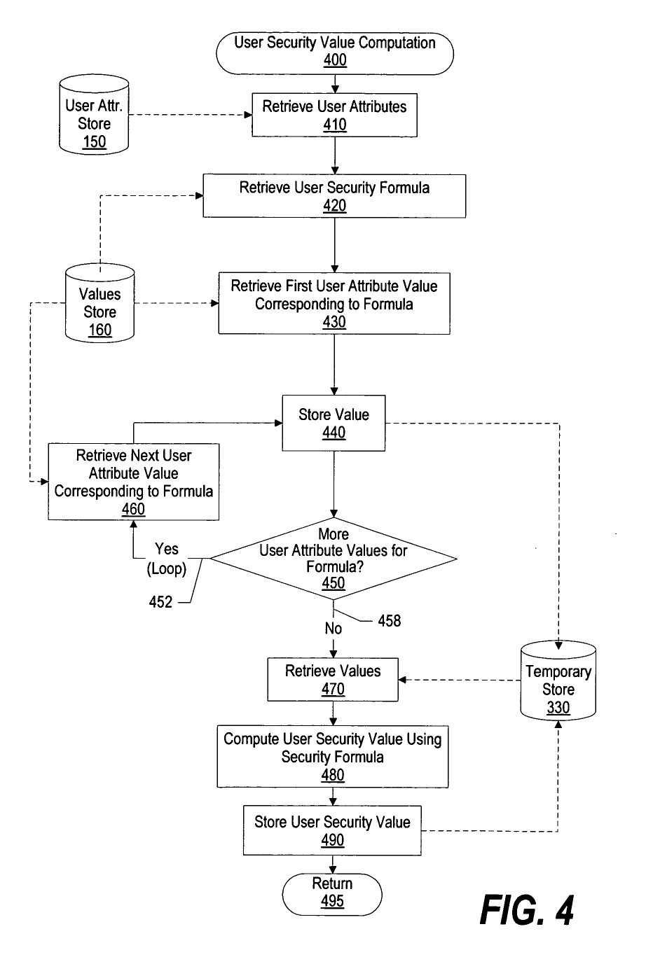

Dynamic security system 130 uses the user security formula and the user attribute values to compute a dynamic user security value. The dynamic user security value is a security “value” for user 100 at the time of request 120, and changes based upon user 100's attributes as well as where and when user 100 logs on (see FIG. 4 and corresponding text for further details regarding dynamic user security value computations).

In order to compute a resource security value for the requested resource, dynamic security system 130 retrieves resource attributes 165 from resource store 170. Resource attributes 165 correspond to the requested resource, and may include the resource's document type (program, code, etc.) and document status (draft, approved, etc.). Request 120 may also be associated with a hardware resource, such as accessing a router to configure the router.

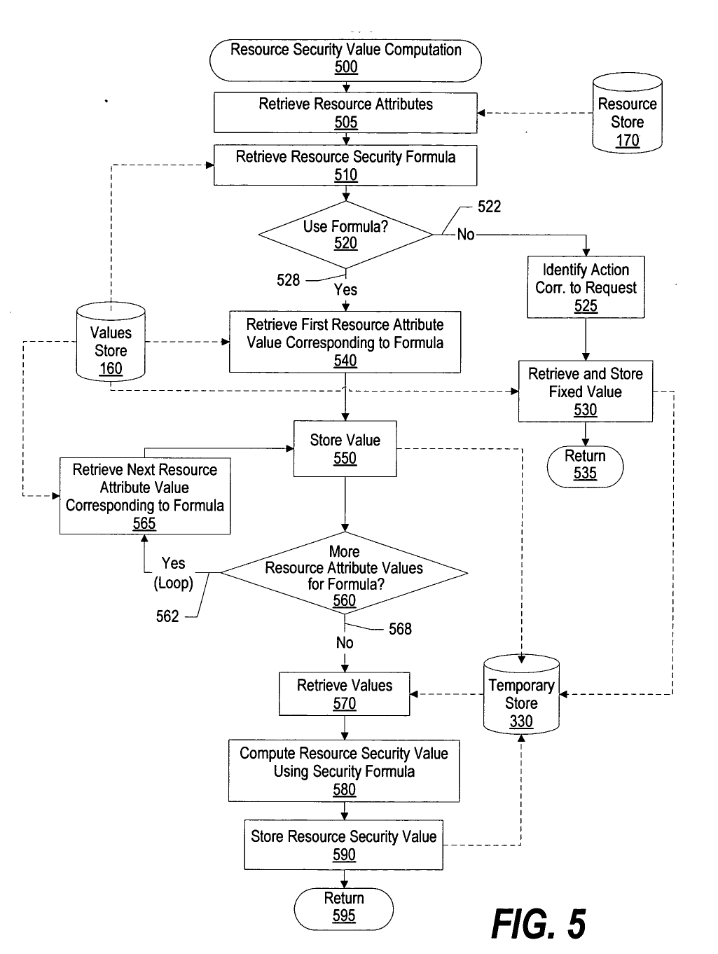

Dynamic security system 130 then retrieves a resource security formula from values store 160, and retrieves resource attribute values for use in the resource security formula based upon resource attributes 165. In turn, dynamic security system 130 computes a resource security value using the resource security formula and the retrieved resource attribute values (see FIG. 5 and corresponding text for further details regarding resource security value computations). In one embodiment, dynamic security system 130 uses fixed values that are based upon the type of request 120, such as whether user 100 wishes to view a resource or write to a resource.

Once dynamic security system 130 completes security value computations, dynamic security system 130 determines whether to authorize request 120 based upon the values of the dynamic user security value and the resource security value. For example, if user 100's dynamic user security value is “18,” and the resource's resource security value is “25,” then dynamic security system 130 does not authorize user 100 access to the resource. On the other hand, if user 100's dynamic user security value is “18,” and the resource's resource security value is “8,” then dynamic security system 130 retrieves the resource (resource 180) from resource store 170, and provides resource 180 to user 100.

In one embodiment, the dynamic user security value and the resource security value calculations may be based upon a Boolean set of policy statements. For example, if USER=Bill, LOCATION=Austin, TIME=Day, ACTIVITY=low OR normal, set the dynamic user security value to “HIGH.” In this example, if an administrator decided to be ultraconservative, any change from these values may drop the user's dynamic user security value to “ANYONE” so that user “Bill” could only get publicly accessible files. In this embodiment using Boolean policies, many such policies would be likely. In addition, wildcards (e.g., regional or group membership) may be used to reduce the number of policies that aid the policy administration if changes are required.

FIG. 2A is a table showing various user attributes and corresponding values. An administrator generates a user attribute formula that includes user attributes in order to compute a dynamic user security value. The values of the user attributes (e.g., user attribute values) depend upon the user requesting access.

Table 200 includes a list of user attribute values. Column 205 includes a list of user attributes and column 210 includes a list of corresponding user attribute values. Lines 212-216 include management attribute values that correspond to a user's management level. For example, line 214 shows that the user security formula uses a user attribute value of “1” if a user is a first line manager. Lines 218-222 include position attribute values that correspond to the user's position. For example, line 222 shows that the user security formula uses a user attribute value of “2” if the user is in a support position.

Lines 224-226 include login location attribute values that correspond to the user's login location (internal or external). Lines 228-232 include login quality attribute values that correspond to quality of the user's connection (telnet, SSH, or terminal). Lines 234-240 include department attribute values that correspond to the user's department relative to the requested resource (outsider, same company, same division, same group). Lines 242-246 include login time attribute values that correspond to the time that the user logged in (holiday, after hours, working hours).

Lines 248-250 include prior error attribute values that correspond to prior login attempts (user's prior access history). And, line 252 includes band attribute values that correspond to the user's experience level, such as a “5” for five years of service. A dynamic security system analyzes user attributes, retrieves corresponding user attribute values, and computes a dynamic user security value using the user security formula (see FIG. 4 and corresponding text for further details)

FIG. 2B is a table showing various resource attribute values. An administrator generates a resource attribute formula that includes resource attributes in order to compute a resource security value. The values of the resource attributes (e.g., resource attribute values) depend upon various factors, such as the resource's document type and document status.

Table 260 includes a list of resource attribute values. Column 265 includes a list of resource attributes and column 270 includes a list of corresponding resource attribute values. Lines 272-276 include document type attribute values that correspond to the requested resource. For example, line 274 shows that the resource security formula uses a resource attribute value of “5” if the resource document type is code. Lines 278-284 include document status attribute values that correspond to the requested resource. For example, line 282 shows that the resource security formula uses a resource attribute value of “5” if the resource document status is approved.

Lines 286-290 include access type fixed values that an administrator may use for the resource security value instead of using a formula to compute the resource security value. For example, if the resource request pertains to a note insertion, line 288 shows that the resource security value is “10” and, therefore, a user is required to have a dynamic user security value greater than 10 in order to insert notes into a resource (see FIG. 5 and corresponding text for further details).

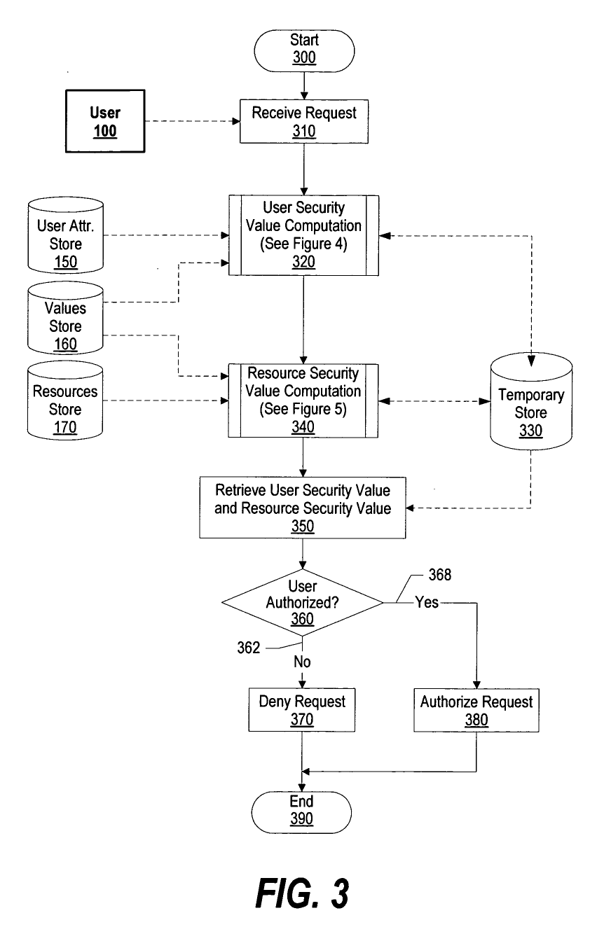

FIG. 3 is a high level flowchart showing steps taken in computing a dynamic user security value and a resource security value, and granting a user access to a resource based upon the security values. Processing commences at 300, whereupon processing receives a resource request from user 100 at step 310. User 100 is the same as that shown in FIG. 1, and is requesting access to a particular resource, such as a database.

Processing retrieves user attributes that correspond to user 100 from user attributes store 150, along with a user security formula from values store 160 to compute a dynamic user security value. For example, user 100 may be a first line manager that is logging in remotely, which is in the same department that is assigned to the requested resource. In this example, the user security formula computes the dynamic user security value using attribute values for user 100's situation. The resultant dynamic user security value is stored in temporary store 330 (pre-defined process block 320, see FIG. 4 and corresponding text for further details). User attribute store 150 and values store 160 are the same as that shown in FIG. 1. Temporary store 330 may be stored on a nonvolatile storage area, such as a computer hard drive.

Processing then retrieves resource attributes that correspond to the requested resource from resources store 170, along with a resource security formula from values store 160 to compute a resource security value. For example, the resource may be software code that is in draft mode and, in this example, the resource security formula retrieves a software code attribute value and a draft mode attribute value to compute the resource security value. The resultant resource security value is stored in temporary store 330 (pre-defined process block 340, see FIG. 5 and corresponding text for further details). Resources store 170 is same as that shown in FIG. 1.

At step 350, processing retrieves the dynamic user security value and the resource security value from temporary store 330. A determination is made as to whether to authorize the resource request based upon the dynamic user security value and the resource security value (decision 360). For example, processing may grant resource requests when the dynamic user security value is greater than or equal to the resource security value, and deny resource requests when the dynamic user security value is less than the resource security value.

If the dynamic user security value is greater than or equal to the resource security value, decision 360 branches to “Yes” branch 368 whereupon processing authorizes the resource request at step 380. On the other hand, if the dynamic user security value is less than the resource security value, decision 360 branches to “No” branch 362 whereupon processing denies user 100's resource request at step 370. Processing ends at 390.

FIG. 4 is a flowchart showing steps taken in computing a dynamic user security value using a user security formula and a plurality of user attribute values.

Processing commences at 400, whereupon processing retrieves user attributes from user attribute store 150 at step 410. The user attributes correspond to the user that is requesting access to a particular resource, such as the user's department and the user's position (see FIG. 2A and corresponding text for further details regarding user attributes). User attribute store 150 is the same as that shown in FIG. 1.

At step 420, processing retrieves a user security formula from values store 160. An administrator generates and manages the user security formula, which produces a dynamic user security value. For example, a user security formula may be:
DUSV=MAV+PAV+LLAV+LQAV+DAV+LTAV+BAV+EAV

where
DUSV=dynamic user security value
MAV=management attribute value
PAV=position attribute value
LLAV=login location attribute value
LQAV=login quality attribute value
DAV=department attribute value
LTAV=login time attribute value
BAV=band attribute value
EAV=error attribute value

In the example above, each user attribute is treated equally. In one embodiment, the user security formula may include user weightings that are associated with the user attributes. The user weightings may adjust based upon a user's particular “request conditions,” such as the user status, the user's group membership, the time-of-day of the request, and the user's location. In yet another embodiment, processing may select a particular user security formula from a plurality of user security formulas based upon the request conditions mentioned above.

In still yet another embodiment, a system administrator may wish to apply more weighting to a user's login location because the company is receiving malicious attempts to access resources from personnel outside the company. In this embodiment, the administrator may change the user security formula to:
DUSV=MAV+PAV+5*LLAV+LQAV+5*DAV+LTAV+BAV+EAV

In this embodiment, the administrator also adjusts a resource security formula to generate higher resource security values for resources, especially sensitive documents (see FIG. 5 and corresponding text for further details regarding resource security formula details). As such, the heavily weighted variables in the above formula become important factors for gaining access to resources. Values store 160 is the same as that shown in FIG. 1.

At step 430, processing retrieves a user attribute value corresponding to a first user attribute that is included in the user security formula from values store 160. Using the examples described above, processing retrieves a management attribute value (MAV) corresponding to the user. For example, one of the user's retrieved, attributes may be the user's management ranking, which is a “first line” manager. In this example, processing retrieves a value that is associated with a first line management level (see FIG. 2A and corresponding text for further details regarding user attribute values). At step 440, processing stores the retrieved user attribute value in temporary store 330. Temporary store 330 is the same as that shown in FIG. 3.

A determination is made as to whether the user security formula requires more user attribute values in order to compute the dynamic user security value (decision 450). If the user security formula requires more user attribute values, decision 450 branches to “Yes” branch 452 whereupon processing loops back to retrieve the next user attribute value from values store 160 corresponding to the user (step 460), and store the retrieved value in temporary store 330 (step 440). This looping continues until there are no more user attribute values to retrieve for the user security formula, at which point decision 450 branches to “No” branch 458.

At step 470, processing retrieves the stored user attribute values and, at step 480, processing computes the dynamic user security value by including the user attribute values into the user security formula. For example, with user attribute values being: MAV=1, PAV=2, LLAV=0, LQAV=2, DAV=3, LTAV=2, BAV=2, EAV=1, and using the formula in the first example discussed above, the dynamic user security value may be computed as follows:
DUSV=MAV+PAV+LLAV+LQAV+DAV+LTAV+BAV+EAV
DUSV=1+2+0+2+3+2+2+1=13

Processing stores the computed dynamic user security value in temporary store 330 at step 490, and returns at 495.

FIG. 5 is a flowchart showing steps taken in computing a resource security value using a resource security formula and a plurality of resource attribute values.

Processing commences at 500, whereupon processing retrieves resource attributes from resource store 170 at step 505. The resource attributes correspond to the requested resource, such as the resource's document status (e.g., draft, approved draft, etc.) (see FIG. 2B and corresponding text for further details regarding resource attributes). Resource store 170 is the same as that shown in FIG. 1.

At step 510, processing retrieves a resource security formula from values store 160. An administrator generates and manages the resource security formula, which produces a resource security value. For example, a resource security formula may be:
DRSV=DTAV+DSAV

where
DRSV=resource security value
DTAV=document type attribute value
SAV=document status attribute value

In the example above, each resource attribute is treated equally. In one embodiment, the resource security formula is based upon a computer network's environmental conditions. For example, if the computer network is under a malicious attack, processing may select a stricter resource security formula or adjust variables in the resource security formula in order to increase resource security values.

In yet another example, a system administrator may wish to use access type fixed values for particular access requests, such as
DRSV=5 for read access request
DRSV=10 for note insertion access request
DRSV=15 for write access request

In the above examples, the administrator only needs to change the resource security formula or the access type fixed values to increase resource security levels, and does not need to change each resource's security access requirements.

A determination is made as to whether the resource security formula is a fixed value or requires computation (decision 520). For example, an administrator may set a flag that instructs processing whether to use a fixed value or a formula. If processing should use a fixed value, decision 520 branches to “No” branch 522 whereupon processing identifies an action that corresponds to the resource request, such as a read request or write request (step 525). At step 530, processing retrieves a value corresponding to the identified action from values store 160 and stores the value in temporary store 330. This fixed value becomes the resource security value. Temporary store 330 is the same as that shown in FIG. 3. Processing returns at 535.

On the other hand, if processing should compute a resource security value, decision 520 branches to “Yes” branch 528 whereupon processing retrieves a resource attribute value corresponding to a first resource attribute that is included in the resource security formula from values store 160 (step 540). Using the example described above, processing retrieves a document type attribute value (DTAV) corresponding to the requested resource. At step 550, processing stores the retrieved resource attribute value in temporary store 330.

A determination is made as to whether the resource security formula requires more resource attribute values in order to compute the resource security value (decision 560). If the resource security formula requires more resource attribute values, decision 560 branches to “Yes” branch 562 whereupon processing loops back to retrieve the next resource attribute value from values store 160 corresponding to the requested resource (step 565), and store the retrieved value in temporary store 330 (step 550). This looping continues until there are no more resource attribute values to retrieve for the resource security formula, at which point decision 560 branches to “No” branch 568.

At step 570, processing retrieves the stored resource attribute values and, at step 580, processing computes the resource security value using the resource attribute values and the resource security formula. For example, with resource attribute values being: DTAV=5 and DSAV=2, and using the formula discussed above, the resource security value may be computed as follows:
DRSV=DTAV+DSAV
DRSV=5+2=7

Processing stores the computed resource security value in temporary store 330 at step 590, and returns at 595.

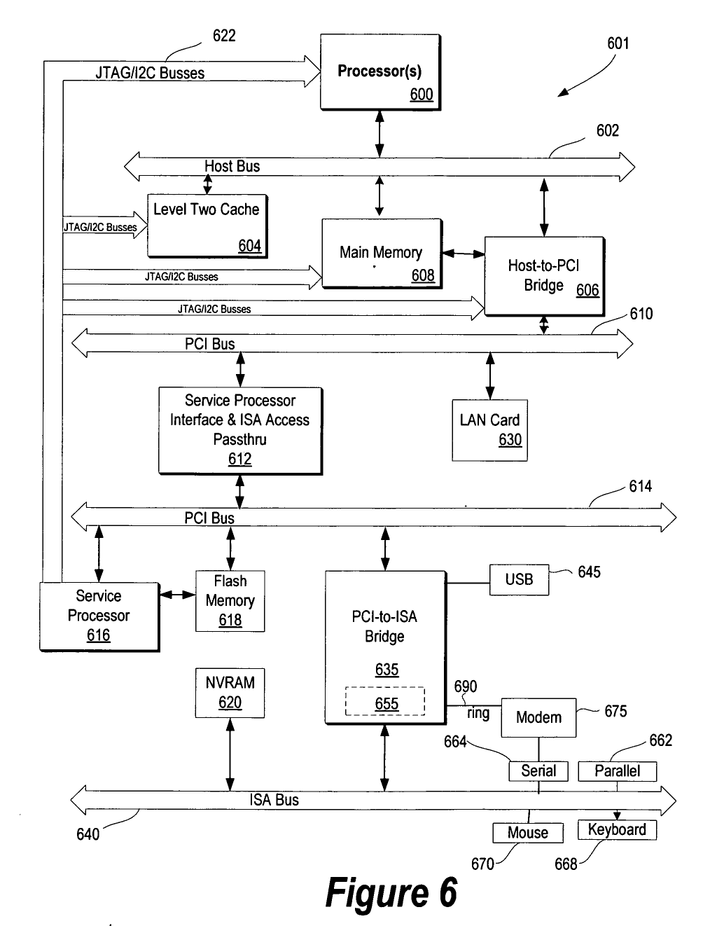

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 665 is connected to serial port 664 and PCI-to-ISA Bridge 635.

While FIG. 6 shows one information handling system that employs processor(s) 600, the information handling system may take many forms. For example, information handling system 601 may take the form of a desktop, server, portable, laptop, notebook, or other form factor computer or data processing system. Information handling system 601 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of .this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving a resource request from a user, the resource request corresponding to a resource;
computing a dynamic user security value that corresponds to the user;
computing a resource security value that corresponds to the resource;
determining whether to grant the user access to the resource based upon the dynamic user security value and the resource security value; and
granting the user access to the resource in response to the determination.

2. The method of claim 1 wherein computing the dynamic user security value further comprises:
retrieving a plurality of user attribute values that are associated with the user;
retrieving a user security formula; and
using the plurality of user attribute values with the user security formula for computing the dynamic user security value.

3. The method of claim 2 wherein at least one of the plurality of user attribute values is selected from the group consisting of a management attribute value, a position attribute value, a login location attribute value, a login type attribute value, a department attribute value, a login time attribute value, and a prior errors attribute value.

4. The method of claim 2 further comprising:
retrieving a login time attribute value based upon the user's login time;
retrieving a login location attribute value corresponding to the user's login location;
identifying a prior errors attribute value corresponding to the user's prior login attempts;
retrieving a department attribute value corresponding to the user's department; and
using the login time attribute value, the login location attribute value, the prior errors attribute value, and the department attribute value for computing the dynamic user security value.

5. The method of claim 2 further comprising:
selecting the user security formula from a plurality of user security formulas, the selecting based upon at least one request condition that is selected from the group consisting of a user status, a group membership, a time-of-day, and a user location.

6. The method of claim 2 wherein the user security formula includes one or more user weightings that adjusts based upon at least one request condition that is selected from the group consisting of a user status, a group membership, a time-of-day, and a user location.

7. The method of claim 1 wherein computing the resource security value further comprises:
retrieving a plurality of resource attribute values that are associated with the resource;
retrieving a resource security formula; and
using the plurality of resource attribute values with the resource security formula for computing the resource security value.

8. The method of claim 7 wherein at least one of the plurality of resource attribute values is selected from the group consisting of a document type attribute value, a document status attribute value, and an access type attribute value.

9. The method of claim 7 wherein the resource security formula is based upon one or more network environmental conditions.

10. The method of claim 1 wherein the resource security value is an access type fixed value that is associated with the resource request.

11. A computer program product comprising:
a computer operable medium having computer readable code, the computer readable code being effective to:
receive a resource request from a user, the resource request corresponding to a resource;
compute a dynamic user security value that corresponds to the user;
compute a resource security value that corresponds to the resource;
determine whether to grant the user access to the resource based upon the dynamic user security value and the resource security value; and
grant the user access to the resource in response to the determination.

12. The computer program product of claim 11 wherein the computer readable code is further effective to:
retrieve a plurality of user attribute values that are associated with the user;
retrieve a user security formula; and
use the plurality of user attribute values with the user security formula for computing the dynamic user security value.

13. The computer program product of claim 12 wherein at least one of the plurality of user attribute values is selected from the group consisting of a management attribute value, a position attribute value, a login location attribute value, a login type attribute value, a department attribute value, a login time attribute value, and a prior errors attribute value.

14. The computer program product of claim 12 wherein the computer readable code is further effective to:
retrieve a login time attribute value based upon the user's login time;
retrieve a login location attribute value corresponding to the user's login location;
identify a prior errors attribute value corresponding to the user's prior login attempts;
retrieve a department attribute value corresponding to the user's department; and
use the login time attribute value, the login location attribute value, the prior errors attribute value, and the department attribute value for computing the dynamic user security value.

15. The computer program product of claim 11 wherein the computer readable code is further effective to:
retrieve a plurality of resource attribute values that are associated with the resource;
retrieve a resource security formula; and
use the plurality of resource attribute values with the resource security formula for computing the resource security value.

16. An information handling system comprising:
one or more processors;
a memory accessible by the processors;
one or more nonvolatile storage devices accessible by the processors; and
a dynamic security access tool for granting user access to resources, the dynamic security access tool being effective to:
receive a resource request from a user, the resource request corresponding to a resource;
compute a dynamic user security value that corresponds to the user;
compute a resource security value that corresponds to the resource;
determine whether to grant the user access to the resource based upon the dynamic user security value and the resource security value; and
grant the user access to the resource located in one of the nonvolatile storage devices in response to the determination.

17. The information handling system of claim 16 wherein the dynamic security access tool is further effective to:
retrieve a plurality of user attribute values from one of the nonvolatile storage devices that are associated with the user;
retrieve a user security formula from one of the nonvolatile storage devices; and
use the plurality of user attribute values with the user security formula for computing the dynamic user security value.

18. The information handling system of claim 17 wherein at least one of the plurality of user attribute values is selected from the group consisting of a management attribute value, a position attribute value, a login location attribute value, a login type attribute value, a department attribute value, a login time attribute value, and a prior errors attribute value.

19. The information handling system of claim 17 wherein the dynamic security access tool is further effective to:
retrieve a login time attribute value from one of the nonvolatile storage devices based upon the user's login time;
retrieve a login location attribute value from one of the nonvolatile storage devices corresponding to the user's login location;
identify a prior errors attribute value corresponding to the user's prior login attempts;
retrieve a department attribute value from one of the nonvolatile storage devices corresponding to the user's department; and
use the login time attribute value, the login location attribute value, the prior errors attribute value, and the department attribute value for computing the dynamic user security value.

20. The information handling system of claim 16 wherein the dynamic security access tool is further effective to:
retrieve a plurality of resource attribute values from of the nonvolatile storage devices that are associated with the resource;
retrieve a resource security formula from one of the nonvolatile storage devices; and
use the plurality of resource attribute values with the resource security formula for computing the resource security value.
